(19) United States
(12) Patent Application Publication
(10) Pub. No.: US 2024/0384740 A1
(43) Pub. Date: Nov. 21, 2024

(54) BRACKET FOR CONNECTING FURNITURE PARTS AT RIGHT ANGLES

(71) Applicant: Brian Fulton, Westminster, CA (US)

(72) Inventor: Brian Fulton, Westminster, CA (US)

(21) Appl. No.: 18/198,392

(22) Filed: May 17, 2023

(51) Int. Cl. F16B 12/14

(52) U.S. Cl. CPC F16B 12/14; F16B 2012/145

(57) ABSTRACT

The present invention provides a connection system for connecting two furniture parts at right angles. A bracket has an exterior part and an insertable part. Both parts are connected to one another at a right angle. A threaded hole extends through the insertable part. A screw extends through the threaded hole and the two furniture parts are connected at a right angle as the screw is tightened.

The present invention relates to furniture hardware, and in particular, to hardware used to connect furniture parts to one another.

### BACKGROUND OF THE INVENTION

Furniture construction is well known in the prior art. There are many devices and mechanisms available to strengthen and simplify the furniture construction process. Many of these devices, however, are expensive and complicated to use.

What is needed is an inexpensive, efficient device and method for connecting furniture parts at right angles.

### SUMMARY OF THE INVENTION

The present invention provides a connection system for connecting two furniture parts at right angles. A bracket has an exterior part and an insertable part. Both parts are connected to one another at a right angle. A threaded hole extends through the insertable part. A screw extends through the threaded hole and the two furniture parts are connected at a right angle as the screw is tightened.

### BRIEF DESCRIPTION OF THE DRAWINGS

FIG. 1 shows a furniture top part.

FIG. 2 shows a furniture frame.

FIG. 3 shows a furniture side part.

FIG. 4 shows a preferred connection bracket.

FIG. 5 shows a preferred bracket receiving section.

FIG. 6 shows a user grasping a bracket.

FIG. 7 shows a bracket inserted into a bracket receiving section.

FIG. 8 shows the top part connected to the frame by utilization of the connection bracket.

FIG. 9 shows a preferred side part with brackets inserted.

FIG. 10 shows a drawer face connected to a drawer side using a connection bracket.

### DETAILED DESCRIPTION OF THE PREFERRED EMBODIMENTS

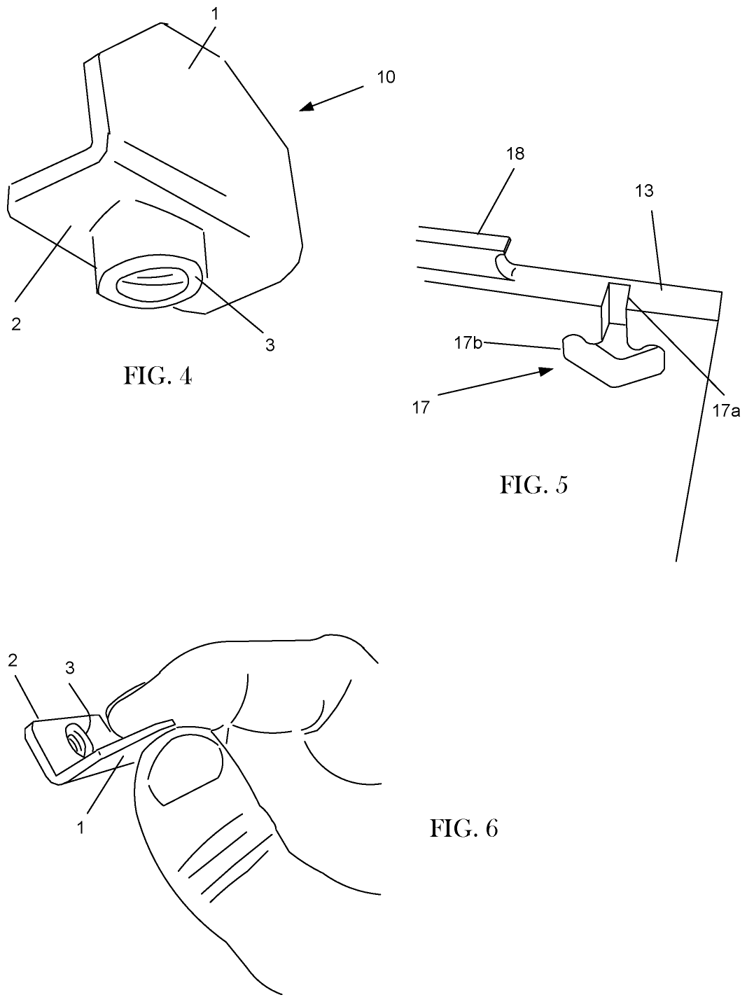

FIG. 4 shows preferred connection bracket 10. Bracket 10 is utilized to connect furniture parts at right angles.

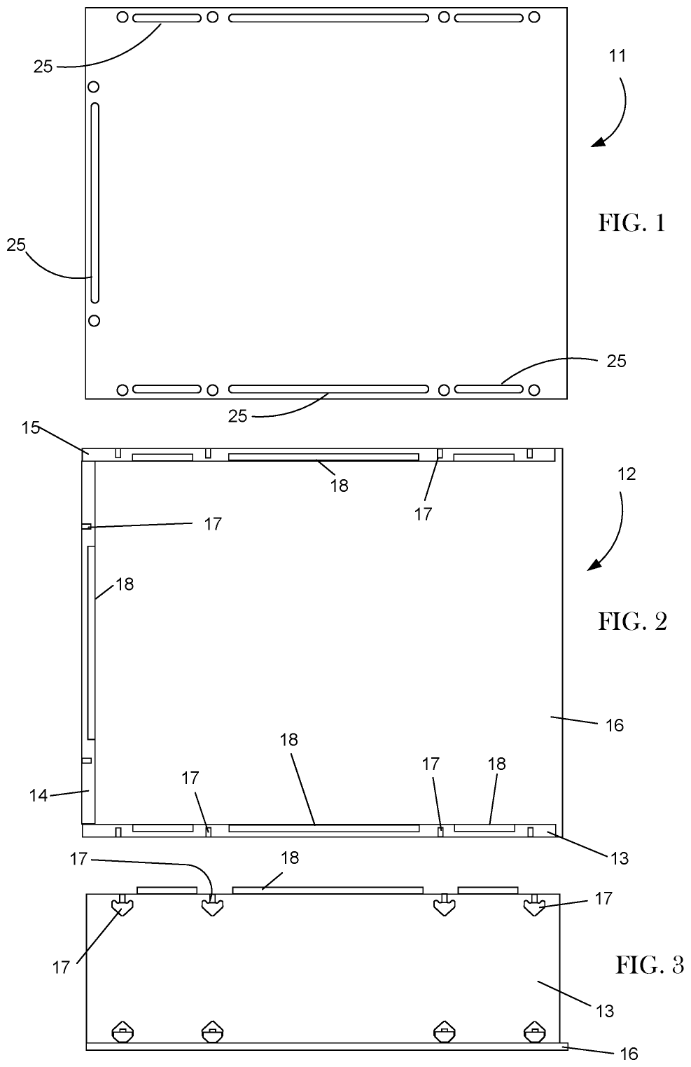

For example, in one preferred embodiment brackets 10 may be utilized to connect top part 11 (FIG. 1) onto frame 12 (FIG. 2). Frame 12 includes side parts 13, 14 and 15 and bottom part 16. Bracket receiving sections 17 are cut into side parts 13, 14 and 15. Keys 18 extend upwards from side parts 13, 14 and 15. FIG. 3 shows a side view of side part 13 and bracket receiving sections 17.

FIG. 5 shows a perspective view of side part 13, including bracket receiving section 17 and key 18. As shown in FIG. 5, bracket receiving section 17 includes insertable part receiving section 17b and screw access section 17a.

FIG. 6 shows a user grasping bracket 10 with his fingers for insertion into a bracket receiving section 17. As shown in FIG. 6 and FIG. 4, bracket 10 includes exterior part 1 connected at a right angle to insertable part 2. Threaded tube section 3 extends through insertable part 2 and is for receiving a threaded screw for furniture attachment.

In FIG. 7 the user has inserted bracket 10 into bracket receiving section 17. Insertable part receiving section 17b provides space for finger access for easy bracket insertion and removal. Bracket 10 is press fit into bracket receiving section 17 and is initially held in place by compressive force. Exterior part 1 forms one wall of a channel along with three walls formed by screw access section 17a. The channel receives a screw as it extends downward into threaded tube section 3. Exterior part 1 also provides strength and support as it lies flush against the wall of side part 13.

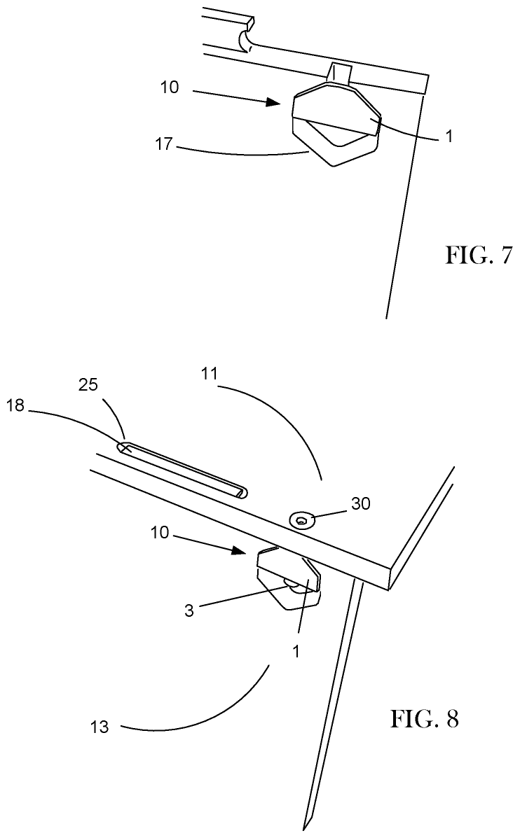

In FIG. 8, the user has placed top part 11 (FIG. 1) onto frame 12 (FIG. 2), which includes side part 13. Keys 18 align with key receiving slots 25. Hex screw 30 is inserted through hole 35 (FIG. 1) and is threaded into tube section 3 of bracket 10. The user tightens hex screw 30 to achieve a very strong and sturdy connection.

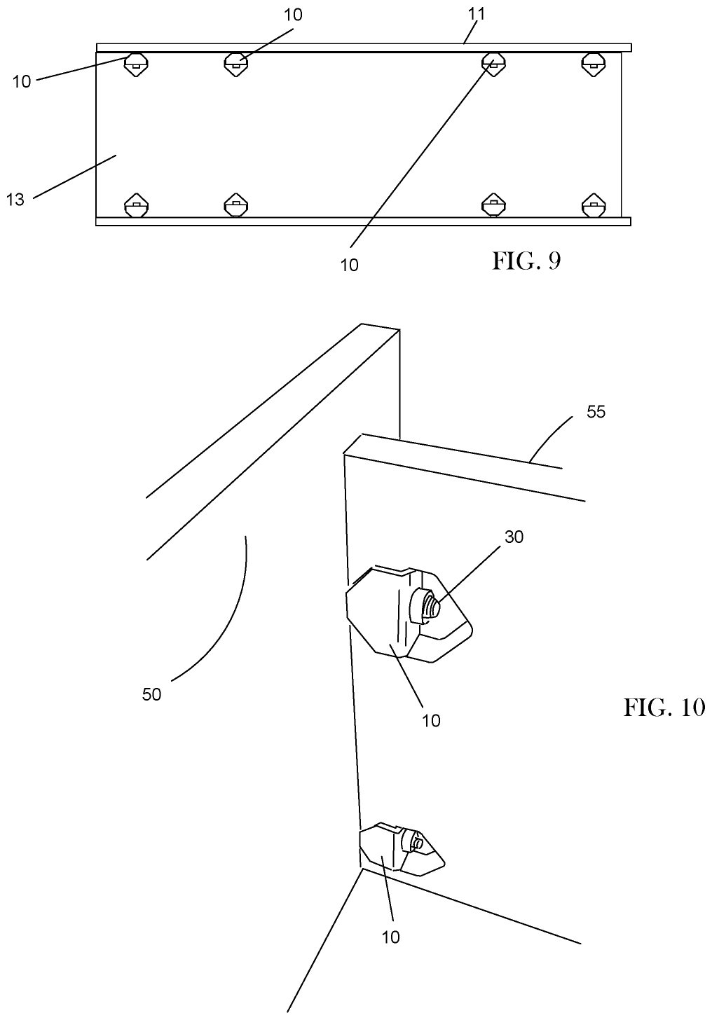

In a similar fashion the user continues to tighten top part 11 onto frame 12 using brackets 10 and hex screws 30. For example, FIG. 9 shows a side view of side part 13 attached to top part 11 utilizing brackets 10.

Although the above description discussed a specific example of utilizing bracket 10 for furniture part connection, it should be noted that bracket 10 could be utilized to attach a variety of furniture part types to one another at right angles. For example, FIG. 10 shows drawer face 50 connected to drawer side 55 utilizing bracket 10 and a threaded screw 30.

Although the above-preferred embodiments have been described with specificity, persons skilled in this art will recognize that many changes to the specific embodiments disclosed above could be made without departing from the spirit of the invention. Therefore, the attached claims and their legal equivalents should determine the scope of the invention.

What is claimed is:

1. A connection system for connecting two furniture parts at right angles, said connection system comprising:
A. a bracket, comprising:
i. an exterior part,
ii. an insertable part, said insertable part connected to said exterior part at a right angle,
iii. a threaded hole section in said insertable part,
B. a screw extending through said threaded hole section and connecting said two furniture parts at right angles as said screw is tightened.

2. The connection system as in claim 1, wherein one of said two furniture parts is a bracket receiving part comprising a bracket receiving section and the other of said furniture parts is a connectable part to be connected said bracket receiving part.

3. The connection system as in claim 2, wherein said bracket receiving section comprises a screw access section and an insertable part receiving section.

4. The connection system as in claim 3, wherein said exterior part lies flush against said bracket receiving part and provides one wall of a screw access channel.

5. The connection system as in claim 3, wherein said insertable part is inserted into said insertable part receiving section.

6. The connection system as in claim 3, wherein said threaded hole section is a threaded tube extending downward from said insertable part.

7. The connection system as in claim 3, wherein said insertable part receiving section provides finger access for bracket insertion and removal.

8. The connection system as in claim 3, wherein screw extends through said connectable part into said bracket to connect said connectable part to said bracket receiving part at a right angle.

9. A method for connecting two furniture parts at right angles, said method comprising the steps of:
A. acquiring a bracket, said bracket comprising:
i. an exterior part,
ii. an insertable part, said insertable part connected to said exterior part at a right angle, and
iii. a threaded hole section in said insertable part,
B. extending a screw through said threaded hole section,
C. connecting said two furniture parts at right angles as said screw is tightened.

10. The method as in claim 9, wherein one of said two furniture parts is a bracket receiving part comprising a bracket receiving section and the other of said furniture parts is a connectable part to be connected said bracket receiving part.

11. The method as in claim 10, wherein said bracket receiving section comprises a screw access section and an insertable part receiving section.

12. The method as in claim 11, wherein said exterior part lies flush against said bracket receiving part and provides one wall of a screw access channel.

13. The method as in claim 11, wherein said insertable part is inserted into said insertable part receiving section.

14. The method as in claim 11, wherein said threaded hole section is a threaded tube extending downward from said insertable part.

15. The method as in claim 11, wherein said insertable part receiving section provides finger access for bracket insertion and removal.

16. The method as in claim 11, wherein screw extends through said connectable part into said bracket to connect said connectable part to said bracket receiving part at a right angle.
